(19) United States
(12) Patent Application Publication
(10) Pub. No.: US 2008/0226517 A1
(43) Pub. Date: Sep. 18, 2008

(54) Catalytic Reactor

(75) Inventors: John Vitucci, Spring, TX (US); Michael Joseph Bowe, Lancashire (GB)

Correspondence Address: LAW OFFICES OF WILLIAM H. HOLT, 12311 HARBOR DRIVE, WOODBRIDGE, VA, 22192, US

(73) Assignee: GTL MICROSYSTEM AG, Zug (CH)

(21) Appl. No.: 11/813,866

(22) PCT Filed: Dec. 19, 2005
(86) PCT No.: PCT/GB05/50254

§ 371 Date: Jul. 13, 2007

(30) Foreign Application Priority Data
Jan. 15, 2005 (GB) 0500838.8

(51) Int. Cl. B01J 19/00

(52) U.S. Cl. 422/197

(57) ABSTRACT

A compact catalytic reactor (20) for reforming comprises a reactor module (70) to define a multiplicity of first and second flow channels arranged alternately, for carrying first and second gas flows, and a removable gas-permeable catalyst structure (80) with a substrate for example of metal foil is provided in each flow channel in which a chemical reaction is to occur. The reactor is for use with a first gas flow whose pressure is above ambient pressure and is no less than that of the second gas flow. The reactor module (70) may be formed of a stack of plates (72, 74, 75). The module (70) is enclosed within a pressure vessel (90), the pressure within the pressure vessel being arranged to be at a pressure substantially that of the first gas flow. Consequently no parts of the module (70) are under tension. This simplifies the design of the reactor module, and increases the proportion of its volume occupied by the catalyst.

This invention relates to a catalytic reactor suitable for use in a chemical process to convert natural gas to longer-chain hydrocarbons, and to a plant including such catalytic reactors to perform the process, and in particular to a catalytic reactor suitable for a reforming process.

A process is described in WO 01/51194 and WO 03/048034 (Accentus plc) in which methane is reacted with steam, to generate carbon monoxide and hydrogen in a first catalytic reactor; the resulting gas mixture is then used to perform Fischer-Tropsch synthesis in a second catalytic reactor. The overall result is to convert methane to hydrocarbons of higher molecular weight, which are usually liquid under ambient conditions. The two stages of the process, steam/methane reforming and Fischer-Tropsch synthesis, require different catalysts, and heat to be transferred to or from the reacting gases, respectively, as the reactions are respectively endothermic and exothermic. The reactors for the two different stages must comply with somewhat different requirements: Fischer-Tropsch synthesis is usually carried out at a higher pressure but a lower temperature than steam/methane reforming; and in the heat transfer channels of the Fischer-Tropsch reactor only a coolant fluid is required, whereas the heat required for steam/methane reforming would typically be provided by catalytic combustion, and so would require a suitable catalyst.

In each case the reactor is preferably formed as a stack of plates, with flow channels defined between the plates, the flow channels for the different fluids alternating in the stack. In those channels that require a catalyst, this is preferably in the form of a corrugated metal substrate carrying the catalyst in a ceramic coating, such corrugated structures being removable from the channels when the catalyst is spent. However, where there is a large pressure difference between the two fluids, this will tend to cause the plates to bend, so heat transfer between the catalyst structure and the plates is impeded, and it may be difficult to remove or replace the catalyst structure; yet if the plates are to be strong enough to resist the pressure difference, then the plates will have to be thicker and/or the channels narrower, and the flow volume as a proportion of the total volume of the reactor will tend to be less.

According to the present invention there is provided a compact catalytic reactor for a reforming reaction comprising a reactor module defining a multiplicity of first and second flow channels arranged alternately in the module, for carrying first and second gas flows, the reactor being suitable for use with a first gas flow whose pressure is above ambient pressure and is no less than that of the second gas flow;

wherein each flow channel in which a chemical reaction is to take place contains a removable gas-permeable catalyst structure incorporating a metal substrate; and
wherein the reactor module is enclosed within a pressure vessel, the pressure within the pressure vessel being arranged to be at a pressure substantially that of the first gas flow.

If the pressure within the pressure vessel is substantially that of the first gas flow, all the flow channels within the reactor module are either at the pressure of the surroundings, or are under compression. Consequently no parts of the reactor module are under tension. Preferably the first gas flow is arranged to flow through at least part of the pressure vessel either to reach the first flow channels or to leave the first flow channels.

The steam/methane reforming reaction typically is carried out at a temperature above 750° C., and the material forming the reforming channels is exposed to the hot reactive gases, so that the material for making the reactor module must be strong and resistant to corrosion at this temperature. Suitable metals are iron/nickel/chromium alloys for high-temperature use, such as Haynes HR-120 or Inconel 800HT (trade marks), or similar materials. The pressure shell does not have to be at such an elevated temperature, and may for example be of a less expensive material such as carbon steel. Preferably the reactor module is provided with thermal insulation, to reduce heat loss to the pressure shell and hence to the environment. Alternatively, or additionally, the internal surface of the pressure shell may be provided with such thermal insulation.

The proportion of the volume of the reactor module (excluding the catalysts) consisting of structural material may be less than 60%, preferably being less than 50% and may indeed be less than 40%.

Preferably the metal substrate for the catalyst structure is a steel alloy that forms an adherent surface coating of aluminium oxide when heated, for example an aluminium-bearing ferritic steel such as iron with 15% chromium, 4% aluminium, and 0.3% yttrium (eg Fecralloy™). When this metal is heated in air it forms an adherent oxide coating of alumina, which protects the alloy against further oxidation and against corrosion. Where the ceramic coating is of alumina, this appears to bond to the oxide coating on the surface. The substrate may be a foil, a wire mesh or a felt sheet, which may be corrugated, dimpled or pleated; the preferred substrate is a thin metal foil for example of thickness less than 100 μm.

Such a corrugated substrate incorporating catalytic material may be inserted into a flow channel, the flow channels for the reforming reaction alternating with flow channels to provide heat. The metal substrate of the catalyst structure within the flow channels enhances heat transfer and catalyst surface area. The catalyst structures are removable from the channels in the module, so they can be replaced if the catalyst becomes spent. Where the pressure vessel communicates with one set of flow channels, it may be convenient not to provide any header in communication with those flow channels at one end of the module, so that removal and replacement of the catalyst structure can be simply achieved; this may require removal of the reactor module from the pressure vessel.

The reactor module may comprise a stack of plates. For example, the first and second flow channels may be defined by grooves in respective plates, the plates being stacked and then bonded together. Alternatively, the flow channels may be defined by thin metal sheets that are castellated and stacked alternately with flat sheets; the edges of the flow channels may be defined by sealing strips. The stack of plates forming the reactor module is bonded together for example by diffusion bonding, brazing, or hot isostatic pressing.

Reactors suitable for the steam/methane reforming reaction may be constructed in accordance with the invention. Consequently a plant for processing natural gas to obtain longer chain hydrocarbons may incorporate a steam/methane reforming reactor of the invention, to react methane with steam to form synthesis gas. To ensure the required good thermal contact in the steam/methane reforming reactor both the first and the second gas flow channels may be between 10 mm and 2 mm deep, preferably less than 6 mm deep, more preferably in the range 3 mm to 5 mm.

The invention will now be further and more particularly described, by way of example only, and with reference to the accompanying drawings, in which:

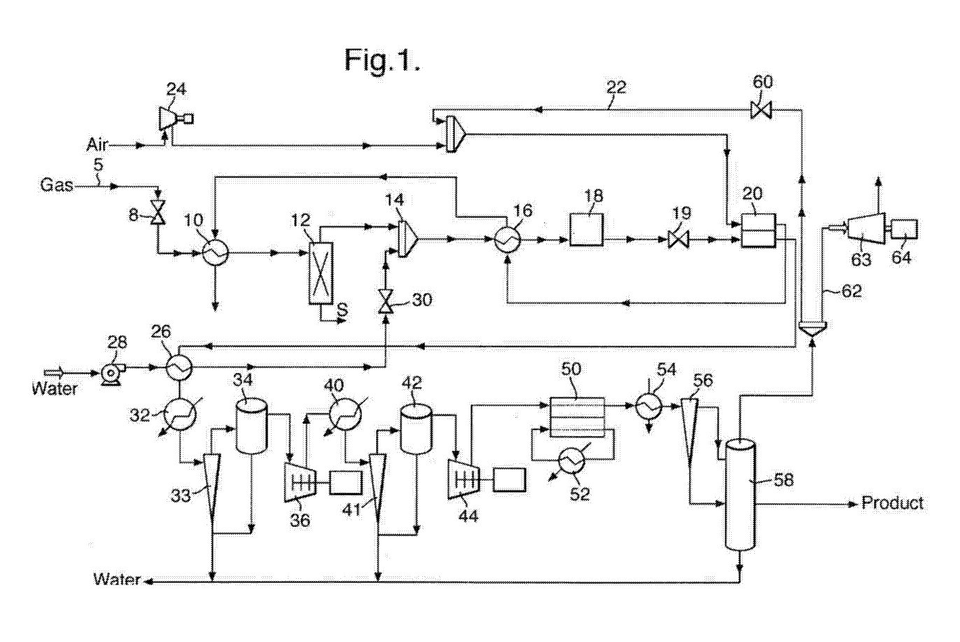

FIG. 1 shows a flow diagram of a chemical plant incorporating a reactor of the invention;

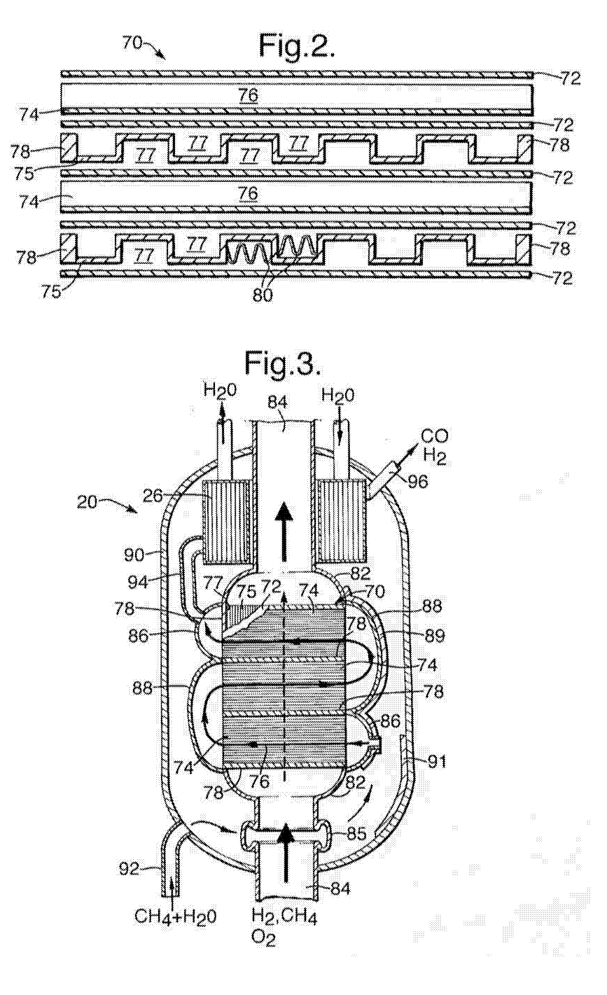

FIG. 2 shows a sectional view of part of a reactor block suitable for steam/methane reforming;

FIG. 3 shows a sectional view of a reactor incorporating the reactor block of FIG. 2.

The invention is of relevance to a chemical process for converting natural gas (primarily methane) to longer chain hydrocarbons. The first stage of this process involves steam reforming, that is to say the reaction of the type:

H₂O+CH₄→CO+3H₂

This reaction is endothermic, and may be catalysed by a rhodium or platinum/rhodium catalyst in a first gas flow channel. The heat required to cause this reaction may be provided by combustion of an inflammable gas such as methane or hydrogen, which is exothermic and may be catalysed by a palladium catalyst in an adjacent second gas flow channel. In both cases the catalyst is preferably on a stabilised-alumina support which forms a coating typically less than 100 μm thick on the metallic substrate. The combustion reaction may take place at atmospheric pressure, but the reforming reaction may take place at between 4 and 5 atmospheres. The heat generated by the combustion would be conducted through the metal sheet separating the adjacent channels.

The gas mixture produced by the steam/methane reforming is then used to perform a Fischer-Tropsch synthesis to generate a longer chain hydrocarbon, that is to say:

nCO+2nH₂→(CH₂)ₙ+nH₂O

which is an exothermic reaction, occurring at an elevated temperature, typically between 190° C. and 280° C., and an elevated pressure typically between 1.8 MPa and 2.1 MPa (absolute values), in the presence of a catalyst such as iron, cobalt or fused magnetite. The preferred catalyst for the Fischer-Tropsch synthesis comprises a coating of gamma-alumina of specific surface area 140-230 m²/g with about 10-40% cobalt (by weight compared to the alumina), and with a promoter such as ruthenium, platinum or gadolinium which is less than 10% the weight of the cobalt, and a basicity promoter such as lanthanum oxide.

Referring now to FIG. 1, the overall chemical process is shown as a flow diagram in which the components of the plant are shown. The natural gas feed 5 consists primarily of methane with, in this example, a percentage of higher hydrocarbons C2 to C11. Typically these higher hydrocarbons are present at up to 10% v/v depending on the source of natural gas. The gas feed 5 may for example be at a pressure of 1.0 MPa (10 atmospheres).

The gas pressure is regulated by a valve 8 to 0.6 MPa and then the gas 5 is pre-heated to about 400° C. in a heat exchanger 10 using the hot exhaust gas from catalytic combustion, and is then fed to a solid bed desulphurising system 12. The de-sulphurised natural gas 5 is then mixed with steam, for example in a fluidic vortex mixer 14. The gas/steam mixture is heated in a heat exchanger 16 using the hot exhaust gas from catalytic combustion so that the gas mixture is at a temperature of 500° C. The mixture enters an adiabatic fixed bed pre-reformer 18 where it contacts a nickel or a platinum/rhodium based methanation catalyst. The higher hydrocarbons react with the steam to form methane and CO.

The gas exits the pre-reformer 18 at a lower temperature typically 450° C. The pressure is then let down by a valve 19 to 0.45 MPa (absolute pressure) before entering a reformer 20. The reformer 20 is a compact catalytic reactor of the type described above, made from a stack of plates which define flow paths for endothermic and exothermic reactions which are in good thermal contact, and which contain appropriate catalysts for example on corrugated metal foils. The reformer channels in the reformer 20 contain a reforming catalyst, and the steam and methane react to form carbon monoxide and hydrogen. The temperature in the reformer increases from 450° C. at the inlet to about 800-850° C. at the outlet. The flow rates of steam and gas supplied to the mixer 14 are such that the steam:carbon molar ratio fed to the reformer 20 is between 1.2-1.6 and preferably between 1.3 and 1.5. Depending on the higher hydrocarbon content of the gas 5, the steam to carbon ratio at the inlet to the pre-reformer 18 will therefore need to be higher than this.

The heat for the endothermic reactions in the reforming reactor 20 is provided by the catalytic combustion of a mixture of short chain hydrocarbons and hydrogen which is the tail gas 22 from the Fischer-Tropsch synthesis; this tail gas 22 is combined with a flow of air provided by an air blower 24. The combustion takes place over a combustion catalyst within adjacent flow channels within the reforming reactor 20. The combustion gas path is co-current relative to the reformer gas path. The catalyst may include gamma-alumina as a support, coated with a palladium/platinum mixture. The combustible gas mixture may be supplied in stages along the reactor 20 to ensure combustion occurs throughout the length of the combustion channels.

A mixture of carbon monoxide and hydrogen at above 800° C. emerges from the reformer 20 and is quenched to below 400° C. by passing it through a steam-raising heat exchanger 26. Water is supplied to this heat exchanger 26 by a pump 28, and the steam for the reforming process is hence supplied through a control valve 30 to the mixer 14. The gas mixture is further cooled in a heat exchanger 32 with cooling water to about 60° C., so the excess water condenses and is separated by passage through a cyclone 33 and a separator vessel 34. The gas mixture is then compressed by a compressor 36 to about 2.5 times the pressure, and is again cooled by a heat exchanger 40 before passing through a second cyclone 41 and a separator vessel 42 to remove any water that condenses. The separated water is re-cycled back to the steam raising circuit. The gas is then compressed to 20 atmospheres (2.0 MPa) in a second compressor 44.

The stream of high pressure carbon monoxide and hydrogen is then fed to a catalytic Fischer-Tropsch reactor 50, which includes channels for a coolant.

The reaction products from the Fischer-Tropsch synthesis, predominantly water and hydrocarbons such as paraffins, are cooled to condense the liquids by passage through a heat exchanger 54 and a cyclone separator 56 followed by a separating chamber 58 in which the three phases water, hydrocarbons and tail gases separate, and the hydrocarbon product is stabilised at atmospheric pressure. The hydrocarbons that remain in the gas phase and excess hydrogen gas (the Fischer-Tropsch tail gases 22) are collected and split. A proportion passes through a pressure reduction valve 60 to provide the fuel for the catalytic combustion process in the reformer 20 (as described above). The remaining tail gases 62 are fed to a gas turbine 63 which drives an electrical power generator 64.

The gas turbine 64 generates all the power for the plant and has the capacity to export a surplus. The major plant electrical power needs are the compressors 36 and 44, and the pumps 24 and 28; electricity may also be used to operate a vacuum distillation unit to provide process water for steam generation.

Referring now to FIG. 2 there is shown a reactor block 70 suitable for use in the steam reforming reactor 20, parts of the reactor block 70 being shown in section and with the components separated for clarity. The reactor block 70 consists of a stack of plates that are rectangular in plan view, each plate being of corrosion resistant high-temperature steel such as Inconel 800HT or Haynes HR-120. Flat plates 72 of thickness 1 mm are arranged alternately with castellated plates 74, 75 in which the castellations are such as to define straight-through channels 76, 77 from one side of the plate to the other. The castellated plates 74 and 75 are arranged in the stack alternately, so the channels 76, 77 are oriented in orthogonal directions in alternate castellated plates 74, 75. The castellated plates 74 and 75 are each of thickness 0.75 mm. The height of the castellations (typically in the range 2-10 mm) is 4 mm in this example, and 4 mm thick solid edge strips 78 are provided along the sides. In the castellated plates 75 which define the combustion channels 77 the wavelength of the castellations is such that successive ligaments are 25 mm apart, while in the castellated plates 74 which define the reforming channels 76 successive ligaments are 15 mm apart.

The stack is assembled as described above, and bonded together corrugated metal foil catalyst carriers 80 (only two of which are shown) are then inserted into the channels, carrying catalysts for the two different reactions. The metal foil is preferably of an aluminium-containing steel alloy such as Fecralloy. Appropriate headers can then be attached to the outside of the stack.

Referring now to FIG. 3, which shows a sectional view through the reactor block 70, each plate 72 is rectangular, of width 600 mm and of length 1200 mm (the section being taken in a plane parallel to one such plate 72). The castellated plates 75 for the combustion channels 77 are of the same area in plan, the castellations running lengthwise. The castellated plates 74 for the reforming channels 76 are 600 mm by 400 mm, three such plates 74 being laid side-by-side, with edge strips 78 between them, with the channels 76 running transversely. Headers 82 at each end of the stack enable the combustion gases to be supplied to, and the exhaust gases removed from, the combustion channels 77 through pipes 84. Small headers 86 (bottom right and top left as shown) enable the gas mixture for the reforming reaction to be supplied to the channels 76 in the first of the castellated plates 74, and the resulting mixture to be removed from those in the third castellated plate 74; double-width headers 88 (top right and bottom left as shown) enable the gas mixture to flow from one castellated plate 74 to the next. The overall result is that the gases undergoing reforming follow a zigzag path that is generally co-current relative to the flow through the combustion channels 77.

The reactor block 70 along with the headers 82, 86 and 88 is mounted within a carbon steel pressure shell 90, cylindrical with hemispherical ends. The pipes 84 are welded to the shell 90 where they pass through it, and expansion bellows 85 are provided in at least one of the pipes 84 to accommodate differential thermal expansion. The outside surfaces of the block 70 and the headers 82, 86 and 88 are provided with a thermal barrier 89 (for example a sprayed-on ceramic thermal insulation; only a part is shown), and the internal surface of the shell 90 is also provided with thermal insulation 91 (only a part is shown). A pipe 92 supplies the steam and methane mixture to the space within the shell 90, and the bottom right header 86 has an opening so that the steam and methane mixture can then flow into the reforming channels 76 as described above. The steam-generating heat exchanger 26 (see FIG. 1) is also within the shell 90; it is of annular construction, surrounding the pipe 84 carrying the exhaust gases. The top left header 86 communicates through a pipe 94 with this heat exchanger 26, and the resulting cooled syngas emerges through a pipe 96.

In use of the reforming reactor 20 the reactor block 70 and the associated headers 82, 86 and 88 are at a temperature in excess of 800° C., the reforming channels 76 typically being at about 820° C. and the combustion channels 77 at about 850° C.; all of these components are of the corrosion resistant high-temperature steel mentioned above. The shell 90, in contrast, is only at about 500° C. The steam and methane mixture is supplied, as mentioned above, at a pressure of 0.45 MPa, so this is the pressure within the shell 90. Consequently the reactor block 70 is exposed to this external pressure. The combustion channels 77 are at approximately atmospheric pressure, and are therefore under compression, but the spacing and thickness of the ligaments defined by the castellated plates 75 are such that this pressure can be withstood without significant deformation.

It will be appreciated that the reactor 20 described in relation to FIGS. 2 and 3 is given by way of example only. For example the castellated plates 74 and 75 may be of a different thickness, typically in the range 0.5-1.0 mm, and the separation between adjacent ligaments is typically in the range 10-20 mm for the reforming channels and between 10 and 40 mm for the combustion channels. The reactor block 70 may be of a different size to that described, and the number of transverse passes for the reforming reaction may be different, and may instead be four or five. It will also be appreciated that the steam generating heat exchanger 26 might not be within the shell 90.

It will be appreciated that the reactor 20 described in relation to FIGS. 2 and 3 is given by way of example only. For example the castellated plates 74 and 75 may be of a different thickness, typically in the range 0.5-1.0 mm, and the separation between adjacent ligaments is typically in the range 10-20 mm for the reforming channels and between 10 and 40 mm for the combustion channels. The reactor block 70 may be of a different size to that described, and the number of transverse passes for the reforming reactor may be different, and may instead be four or five. it will also be appreciated that the steam generating heat exchanger 26 might not be within the shell 90.

It will be appreciated that the use of the external pressure shell 90 helps to reduce the requirement for metal to provide structural strength to the reactor block 70, providing a greater voidage volume and so enabling a higher load of catalyst per unit volume to be achieved. This is because the plates such as 72 can be significantly thinner, so that a larger proportion of the volume of the reactor block is occupied by flow channels, so that the overall catalyst inventory can be increased. For example the proportion of the volume consisting of structural material (considering the reactor module without the catalyst inserts 80) may be about 38%. It also minimises the bending moment in the walls of the flow channels, thereby reducing distortion, so improving contact between the catalyst foil 80 and the adjacent walls and so improving heat transfer, and also making removal or insertion easier. It will be appreciated that the pressure shell 90 has a comparatively simple geometry, so that it can be designed to existing pressure vessel codes. Also it inherently provides a secondary containment in the event of leakage from the reactor block 70; it is of a shape that is easy to insulate, and easy to transport and install; and the overall size of the reactor is not significantly increased.

There is also a cost benefit, as the pressure shell 90 can be made of a comparatively low-cost material such as carbon steel, because its temperature during operation can be significantly lower than that in the reactor block 70; although the reactor block must be made of a higher cost material, the amount of such material that is required is reduced because, as mentioned above, the plates can be significantly thinner than if the pressure shell were not provided.

1. A compact catalytic reactor for a reforming reaction comprising a reactor module defining a multiplicity of first and second flow channels arranged alternately in the module, for carrying first and second gas flows, the reactor being suitable for use with a first gas flow whose pressure is above ambient pressure and is no less than that of the second gas flow;
wherein each flow channel in which a chemical reaction is to take place contains a gas-permeable catalyst structure incorporating a metal substrate; and
wherein the reactor module is enclosed within a pressure vessel, the pressure within the pressure vessel being arranged to be at a pressure substantially that of the first gas flow.

2. A reactor as claimed in claim 1 wherein the first gas flow is arranged to flow through at least part of the pressure vessel either to reach the first flow channels or to leave the first flow channels.

3. A reactor as claimed in claim 1 for performing a reaction at a temperature above 600° C., wherein the reactor module comprises a metal that is strong and resistant to corrosion at the reaction temperature, the reactor module being provided with thermal insulation, and the pressure shell being of a different material to the reactor module.

4. A reactor as claimed in claim 1 wherein the proportion of the volume of the reactor module consisting of structural material is less than 60%.

5. A reactor as claimed in claim 4 wherein the said proportion is less than 50%.

6. A plant for converting natural gas to longer chain hydrocarbons incorporating a steam reforming reactor as claimed in claim 1 to generate a synthesis gas, and a Fischer-Tropsch reactor to generate longer chain hydrocarbons.
